(19) United States
(12) Patent Application Publication
(10) Pub. No.: US 2009/0134793 A1
(43) Pub. Date: May 28, 2009

(54) IR REFLECTING GRATING FOR HALOGEN LAMPS

(76) Inventors: Geza Z. Cseh, Budapest (HU); Peter L. Nagy, Budapest (HU); Ferenc Fazekas, Budapest (HU)

Correspondence Address: Fay Sharpe LLP, 1228 Euclid Avenue, 5th Floor, The Halle Building, Cleveland, OH, 44115, US

(21) Appl. No.: 11/946,223

(22) Filed: Nov. 28, 2007

(51) Int. Cl. H01K 1/26; H01J 9/00

(52) U.S. Cl. 313/580; 445/58

(57) ABSTRACT

A lamp, such as a halogen lamp, includes a bulb which is sealed to define an interior chamber. An emitter, such as a filament, is disposed within the interior chamber which, during operation of the lamp, emits radiation in the visible and infrared regions of the spectrum. An optical grating, generally spaced from the emitter, is positioned to intercept radiation from the emitter. The optical grating reflects infrared radiation and transmits visible radiation therethrough. In this way, the output of the lamp in the visible range can be increased as compared with an otherwise identical lamp formed without the grating.

### BACKGROUND OF THE INVENTION

The exemplary embodiment relates to the illumination arts. It finds particular application in connection with a lamp with an optical grating for increasing efficiency and reducing the emission of infrared radiation from the lamp.

Incandescent halogen lamps radiate a large proportion of their energy as heat, in the infrared (IR) range of the electromagnetic spectrum in accordance with Plank's law. In particular, as the operating temperature the filament increases, the spectral radiance distribution shifts and the peak moves towards shorter wavelengths (in accordance with Wien's law). Even at relatively high operating temperatures of 2,000K-4000K, more of the radiation is emitted in the infrared range than in the visible range.

To reduce the IR emissions and increase the efficiency of the lamp, it is common to provide an IR-reflective coating on the lamp. The coating is formed of multiple alternating layers of materials of high and low refractive index. The coating provides for selective transmission of radiation in the visible range of the electromagnetic spectrum and reflection in the IR range. The process of forming the multi-layer coating is time intensive and generally requires high vacuum techniques, adding a significant cost to the lamp. For example, the coating may include 30-40 layers of different oxides, such as titanium and silicon oxides, deposited on an outer surface of the lamp bulb by chemical vapor deposition (CVD) or physical vapor deposition (PVD) methods.

There remains a need for a coating which reflects IR radiation which can be more simply formed.

### BRIEF DESCRIPTION OF THE INVENTION

In accordance with one aspect of the exemplary embodiment, a lamp includes a bulb which is sealed to define an interior chamber. An emitter is disposed within the interior chamber which, during operation of the lamp, emits radiation in the visible and infrared regions of the spectrum. An optical grating is positioned to intercept radiation from the emitter, the optical grating reflecting infrared radiation and transmitting visible radiation therethrough.

In accordance with another aspect of the exemplary embodiment, a method of forming a lamp includes forming a layer on a transparent substrate, patterning the layer to remove a portion of the layer, and incorporating the transparent substrate with the patterned layer thereon into a lamp, the lamp including an emitter, which during operation of the lamp, emits visible and infrared radiation, the emitter being spaced from the patterned layer. During operation of the lamp, the patterned layer acts as an optical grating which is transmissive to visible radiation and reflects infrared radiation.

In another aspect, a method of operating a lamp includes energizing a radiation emitter of the lamp such that the radiation emitter emits visible and infrared radiation and intercepting the emitted radiation with an optical grating. The optical grating is transmissive to visible radiation and reflects infrared radiation back towards the radiation emitter, whereby the lamp has a higher lumen output per watt than without the optical grating.

### BRIEF DESCRIPTION OF THE DRAWINGS

FIG. 1 is a cross sectional view of an exemplary halogen lamp with an optical grating on a bulb of the lamp in accordance with a first aspect of the exemplary embodiment;

FIG. 2 is a greatly enlarged top view of the optical grating of FIG. 1;

FIG. 3 is a cross sectional view of an exemplary halogen lamp with an optical grating on a bulb of the lamp in accordance with a second aspect of the exemplary embodiment;

FIG. 4 is a cross sectional view of an exemplary halogen lamp with an optical grating on a shroud surrounding a bulb of the lamp in accordance with a fourth aspect of the exemplary embodiment;

FIG. 5 is an enlarged cross sectional view of a substrate with a grating formed thereon to illustrate a mechanism by which infrared radiation is reflected back in to the lamp in accordance with a third aspect of the exemplary embodiment;

FIG. 6 schematically illustrates a method for forming the grating of the lamp of FIG. 1 in accordance with a sixth aspect of the exemplary embodiment;

FIG. 7 schematically illustrates a method for forming the grating of the lamp of FIG. 3 in accordance with a seventh aspect of the exemplary embodiment; and

FIG. 8 is a graph showing power consumption vs. coil resistance for a lamp with a grating and lamps without a grating.

### DETAILED DESCRIPTION OF THE INVENTION

Aspects of the exemplary embodiment relate to a lamp comprising an emitter, such as a filament, gaseous fill, or other source of electromagnetic radiation. During operation of the lamp, the emitter is supplied with energy and emits radiation in the visible region of the electromagnetic spectrum (generally considered to be between about 400 nm and 700 nm) and also in the infrared region of the electromagnetic spectrum (which may be generally considered to be between about 700 nm and 10⁶ nm). In the description below, the lamp is described in terms of an incandescent halogen lamp, although it is to be appreciated that other lamp types are also contemplated.

A transparent substrate is positioned to receive radiation from the emitter. By transparent, it is meant that the substrate transmits substantially all radiation in the visible range, and in some embodiments in both the visible and infrared ranges (e.g., transmits at least 80% and in some embodiments, greater than 90% or greater than 95% of visible radiation). The transparent substrate may be formed of a rigid vitreous material, such as glass or quartz, a rigid polymeric material, or other rigid material capable of retaining its shape at lamp operating temperatures. The substrate may be provided by a lamp bulb which houses the emitter or a generally cylindrical member disposed within the bulb, such as an exhaust tube, or in part by both these components.

The transparent substrate supports an optical grating thereon which inhibits transmission of radiation in at least a portion of the electromagnetic spectrum. In the exemplary embodiment, the optical grating reflects infrared radiation and permits visible radiation to pass therethrough, thereby serving as an infrared reflecting coating or filter. As a result, the proportion of infrared radiation in the radiation emitted by the lamp is reduced, as compared with a lamp that is identical, except that it lacks the optical grating. In one embodiment, where the emitter is filament, the substrate and grating may be spaced from the filament, e.g., by a gaseous fill of the lamp, such that no portion of the filament contacts the grating. By re-directing the IR back to the filament, the lamp produces more light for the same amount of energy and the amount of heat generated by the lamp is reduced when compared to standard halogen lamps.

The grating has the effect of reducing the IR radiation emitted from the lamp, while maintaining or increasing the visible radiation emitted, for a given power input. The increase in visible radiation is achieved by reflecting infrared radiation back to the filament, which increases the operating temperature of the emitter. In one embodiment, the grating transmits a greater percentage of the visible light incident thereon than it does of the infrared radiation. In one embodiment, the optical grating is predominantly transmissive to visible radiation (e.g., transmits at least 60% of the visible radiation incident thereon, and in some embodiments, at least 80%). In one embodiment, the grating inhibits transmission of infrared radiation (e.g., transmits less than 80% of the infrared radiation incident thereon, and in some embodiments, less than 60% or less than 40%). The grating may increase the visible light output of a conventional halogen lamp (measured in terms of lumens/watt) by at least about 10% and in some cases, greater than 30%. For example, in the case of a conventional general lighting purpose halogen lamp which emits about 80-85% of its radiation in the IR range, the efficiency is about 15 lumens/watt (i.e., in the visible range), the lamp output may be increased to about 18-22 lumens/watt be incorporation of the exemplary grating. The grating may substantially surround the emitter such that a predominant proportion of the light that is emitted by the lamp must pass through the grating.

As will be appreciated, in other embodiments, the optical grating may selectively transmit/inhibit transmission of wavelengths other than those solely in the IR range. For example, the grating may inhibit the transmission of radiation of visible radiation of longer wavelengths, such as in the red region of the spectrum, thereby modifying the appearance of the light emitted.

The exemplary optical grating may be in the form of a foraminous film or layer formed by selective removal, in spots, of a coating that has been applied to the substrate. The film/layer may be formed of metal or other infrared reflective material, deposited or otherwise supported on the substrate. The grating may define a pattern of holes, each hole constituting a discrete, spaced region where the metal or other IR reflective material is significantly thinner or absent and that is surrounded by the metal/material. The grating constant (equal to the sum of the hole size and space between the holes) may have a size which is related to the critical wavelength, generally about 0.5-2 times the critical wavelength, and the holes may have a size approximately equal to the half of the grating constant. Since the transmission curve may not provide a sharp cut off, the critical wavelength can be considered to be where the transmission/reflectance curve deflects, e.g., at about 90% reflectance. The critical wavelength is the maximum wavelength permitted to pass through the grating, and may be, for example, in the range of about 700 to about 1000 nm. In other embodiments, the grating may be the substantial inverse of the above, i.e., a plurality of discrete regions of metal (or other reflective material) which are spaced by areas that are free of the metal.

The grating may be formed by depositing a coating of substantially uniform thickness on the substrate followed by selective removal of regions of the coating, for example using laser lithographic techniques or other high energy focused beam or patterning technique.

The exemplary lamp finds application in a variety of applications including household lighting, projection lamps, and illumination in stores.

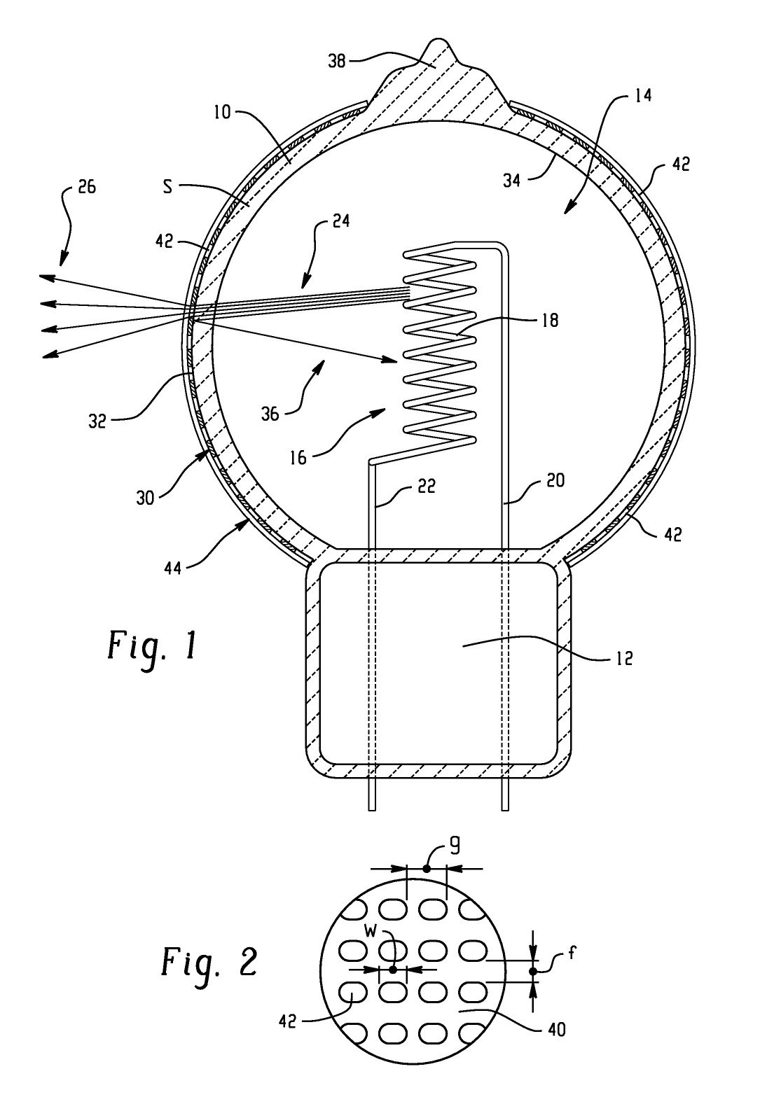

With reference to FIG. 1 one embodiment of an exemplary halogen incandescent lamp is shown. The lamp includes a bulb or envelope 10 which is hermetically sealed, for example, by a pinch seal 12 at one or both ends, to define an interior chamber 14. While FIG. 1 shows a single ended lamp bulb, double ended lamp bulbs are also contemplated. The illustrated bulb 10 is spherical, although it is to be appreciated that the bulb may be ellipsoidal, cylindrical, or other suitable lamp shape. The bulb 10 is formed of a material which is light transmissive, i.e., transmissive to radiation in the visible range and may also be transmissive in the IR range. Suitable materials for forming the bulb include transparent materials, such as quartz glass, and other vitreous materials, although translucent materials, such as ceramic materials, are also contemplated.

The lamp includes a radiation emitter 16. In the illustrated embodiment, the emitter 16 emits radiation in at least the visible range and generally also the IR range of the spectrum. The illustrated emitter 16 includes least one current conducting member, here illustrated as a filament coil 18, which is disposed within the interior chamber 14, and is formed from tungsten or other radiation emissive material. Rather than a coil, other radiation emitters are contemplated, such as a filament wire, ribbon, electrode, electrodeless system, or the like. The filament 18 is connected with an exterior source of electrical power, e.g., via an electronic circuit comprising a ballast (not shown). In the illustrated embodiment, the connection is made via electrically conducting connectors 20, 22, such as wires, passing through the seal 12. Exemplary filament coil 18 extends generally axially in the lamp bulb and, during operation of the lamp, emits radiation, illustrated by exemplary ray 24, in substantially all directions. At least a portion of the radiation is emitted from the lamp in the form of visible light, illustrated by exemplary ray 26.

An optical grating 30 is spaced from filament 18 and is disposed to receive light rays 24. The grating 30 is supported on a transparent substrate S, here provided by the lamp bulb 10. The grating 30 is formed as a coating on an exterior surface 32 of the bulb 10. However, it is also contemplated that the grating 30 may be supported on an interior surface 34 of the bulb 10. In the exemplary embodiment, grating 30 is directly in contact with the bulb surface 32, although it is also contemplated that the grating may be spaced therefrom by an intermediate light transmitting layer.

The optical grating 30 serves to reflect at least a portion of the radiation emitted by the emitter 16. In the illustrated embodiment, the optical grating 30 reflects at least a portion of the IR radiation as shown by exemplary ray 36, back into the interior chamber 14 and thereby reduces IR emissions from the lamp. The reflected IR radiation provides energy to the emitter 16, thereby increasing the efficiency of the lamp. In the exemplary embodiment, grating 30 covers substantially all (e.g., at least 80% or at least 90%) of the radiative, appropriately shaped, portion of the lamp bulb 10 through which radiation is emitted, e.g., the entire surface 32 of the bulb except for pinch portion 12 and optionally a tip portion 38 of the bulb. In other embodiments, the grating 30 may cover less than substantially all of the radiative portion.

The optical grating 30 may be formed from a metal, metalloid, ceramic, or polymer which is capable of withstanding the environment in which it is located. In the example of FIG. 1 it is capable of withstanding normally occurring bulb operating temperatures. The exemplary grating 30 is capable of withstanding and operating effectively at an elevated temperature of, for example 600° C., for a prolonged period of time. In the case of a coating on an interior surface 34 of the bulb, it may also be selected so as to withstand the chemical environment (e.g., halogen gas in the fill). Exemplary metals for forming the grating include copper, palladium, silver, rhodium, silicon carbide, gold or other infrared reflective materials, and combinations thereof. In one embodiment, the grating 30 is predominantly formed of metal, i.e., the grating is more than 50% by weight in the form of elemental metal, e.g., at least 90% or at least 99% elemental metal. By way of example, the grating 30 is formed entirely of pure copper, such as 99% pure copper.

As illustrated in greatly enlarged view in FIG. 2, the grating may be in the form of a single layer film 40 of the metal (e.g., copper) which is patterned by lithography or other technique to define holes 42 therein. The holes 42 extend completely or at least substantially completely through the layer 40 to the underlying substrate. The holes 42 may be formed over the entire layer 40 or over only a portion thereof. As will be appreciated, the holes 42 and their spacing are not shown to scale in FIG. 1, but are shown much enlarged for ease of representation. The holes 42 may be generally circular (e.g., circles or slight ovals or ellipses), as shown, or other more suitable shape, such as generally square (e.g., squares, squares with rounded corners, slightly rectangular shapes), or combinations thereof. The exact shape may be a function of the technique used to create the holes.

The layer 40 may have a thickness of at least about 20 nanometers (nm), and can be less than about 2000 mm, such as 30-500 nm, and in one embodiment, is about 20-100 nm, e.g., 50-80 nm. In general, the layer 40 is thick enough to reflect infrared radiation while not being so thick that the patterning technique is incapable of selective removal of material to form holes.

For reflecting infrared radiation and transmitting visible radiation (e.g., a critical wavelength of about 800 nm), the grating constant may have an approximate size g (average periodic length of the grating) which is less than about 5 μm, e.g., at least about 0.5 μm and in one embodiment, about 1 μm. Thus, for example, there may be at least about 40,000 holes/mm² area of layer 40, and in some cases, at least about 10⁵ or 10⁶ holes/mm². An average spacing f between the holes may be about ¼-¾ of the grating constant (e.g., about 0.1-3 μm) and an average width w of the holes may be about ¼-¾ of the grating constant. For example, the holes 42 may have an approximate width w (average diameter) which is less than about 4 μm, e.g., about 0.1-3 μm and in one embodiment, at least about 0.2 μm, such as about 1 μm.

For the grating 30 to direct infrared effectively back towards the filament 18, and thereby assist in heating the filament, it should be spaced at not too great a distance G from the filament. In general, the grating 30 is less than about 20 mm from the filament 18. e.g., less than about 10 mm. Thus for example, in a spherical halogen bulb of about 12 mm in diameter, the grating is located by a distance G of no more than about 6 mm from the filament. In general, the grating 30 is spaced by a distance g of at least 1 mm from the filament 18, generally out of the Langmuir zone around the filament. On average, therefore, the grating 30 may be spaced from the filament 18 by a distance G of from 1 mm to 20 mm.

A gaseous fill may be hermetically sealed within the bulb chamber 14 and may thus be in contact with the substrate S. An exemplary fill includes a gaseous halogen, which may be in its elemental form and/or a compound thereof. The halogen X may be selected from fluorine, chlorine, bromine, iodine and astatine, or combination thereof. Exemplary halogens include halides, such as HX, e.g., HBr, and alkyl halides RXₙ, where R represents an alkyl group, such as methyl, and n can be from 1 to 3, e.g., methyl bromide. In one embodiment, the fill includes both bromine and methyl bromide. The fill may further include a fill gas, such as nitrogen, xenon, krypton, argon, or mixtures of these gases. In some embodiments, the fill serves as an emitter, either alone or in combination with electrodes.

Optionally, as illustrated in FIG. 1, a protective layer or layers 44 may be formed over the grating 30, such as a layer of a transparent material, such as a fluoride, e.g., magnesium fluoride, a silicon oxide, such as SiO₂, or a combination thereof. In the exemplary embodiment, the layer 44 is substantially contiguous with and in direct contact with the grating 30. The exemplary layer 44 encapsulates the grating 30, protecting it from environmental contamination, oxidation, and/or wear. Where the grating is on an interior surface 34 or otherwise adjacent the fill, the protective layer 44 may be of a suitable composition to protect the grating 30 from the fill components. Alternatively or additionally, the layer 44 may serve as an antireflective coating, in the case where the grating 30 is on the exterior surface 32, or even an IR reflective coating, when the grating is on the interior surface 34. The layer 44 may have a thickness of at least about 10 nm, and generally less than about 1000 nm, e.g., about 100 nm.

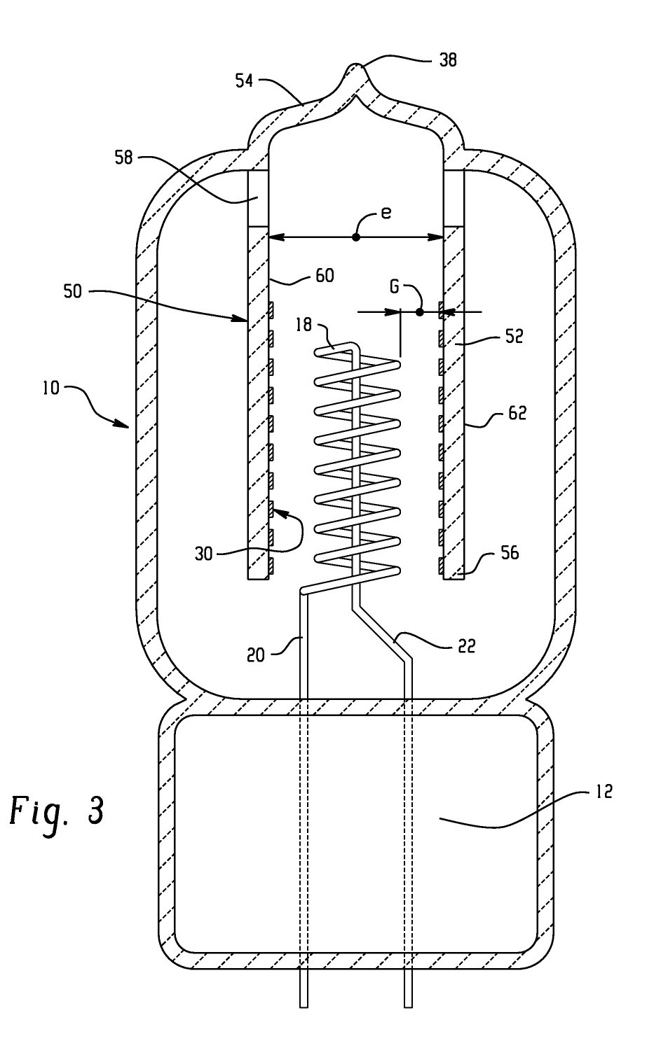

With reference to FIG. 3, another embodiment of a lamp which includes an optical grating 30 is shown. In FIG. 3, similar elements are accorded the same numerals and new elements have new numbers. The lamp includes a cylindrical bulb 10 and an exhaust tube 50 at least partially contained therein. The exhaust tube 50, in this embodiment, serves as a substrate S for the grating 30. The illustrated exhaust tube includes a cylindrical wall 52, which extends into the chamber from adjacent one end of the bulb 10. A dome 54 of the exhaust tube 50 provides the tip of the lamp bulb 10. The filament 18 is generally co-axial with exhaust tube and surrounded thereby such that a lower end 56 of the cylindrical wall 52 (and grating 30) is located below (i.e., extends beyond) the coil 18. The inner diameter e of the exhaust tube 50 is generally greater than the diameter of the Langmuir zone formed around the filament 18 to avoid overheating. The exhaust tube 50 may include one or more convection holes 58, which allow the fill to circulate around the filament coil 18 and prevent the coil and the grating from becoming overheated. A grating 30 is provided on an inner surface 60 of the cylindrical wall 52 and thus extends substantially coaxially around the filament 18. As will be appreciated, grating 30 could alternatively be formed on an exterior surface 62 of the exhaust tube 50.

In the embodiment of FIG. 3, the material of the layer 40 may be selected so as to be resistive to the reactions with the halogens in the fill at the temperature of the bulb inner surface and/or may be protected with a chemical resistant layer 44 analogous to that shown in FIG. 1. For example, for lamps filled with a bromine containing gas, one suitable layer material for forming layer 40 is palladium (Pd). Layer 44, where present, or an additional protective layer, may be heat resistant.

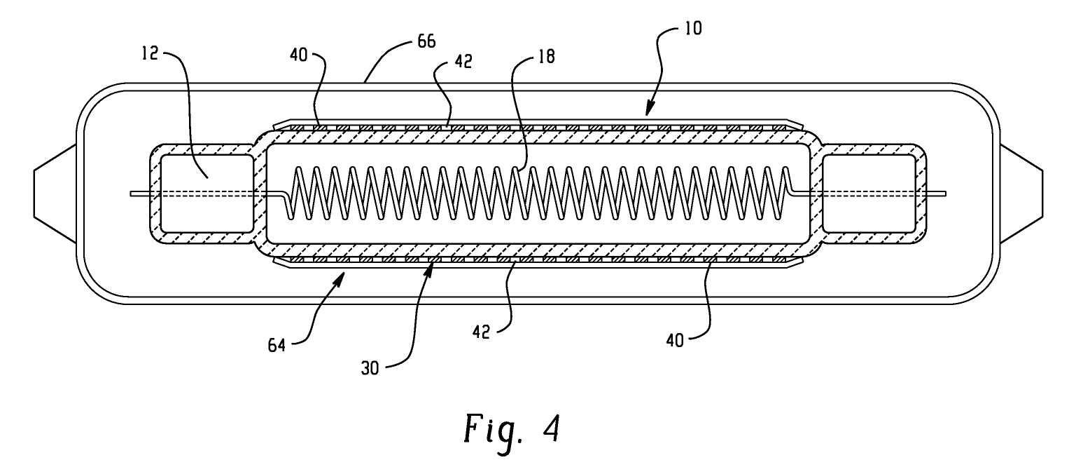

In another embodiment (FIG. 4), the lamp bulb 10 is surrounded by a transparent shroud 64 formed for example, from glass or quartz, on which the grating 30 (not to scale) is supported. An outer envelope 66 surrounds the shroud 64 and the envelope 10.

As will be appreciated, any of the disclosed lamps may be disposed in an outer envelope such as that shown in FIG. 4, or in an envelope with a reflective surface, such as is the case in parabolic aluminized reflector (PAR) lamps or multifaceted reflector (MR) lamps, such as an MR11 or MR16 lamp.

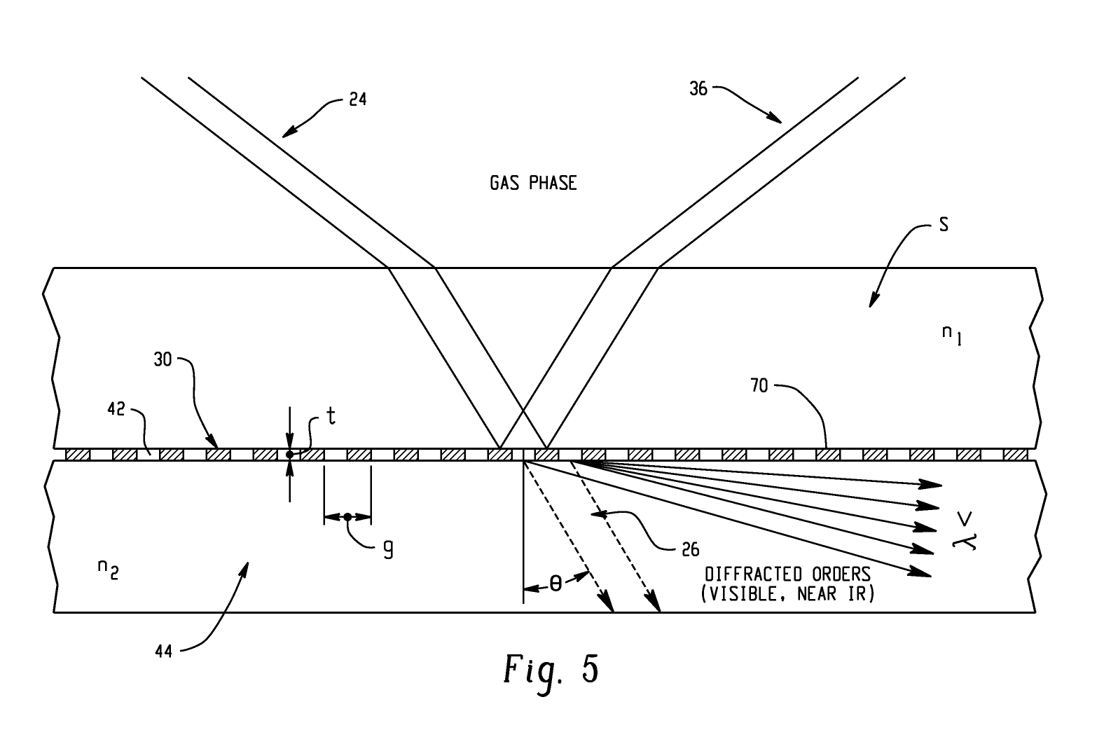

With reference now to FIG. 5, without being bound by any particular theory, an exemplary mechanism by which the grating operates is illustrated. FIG. 5 shows an enlarged cross sectional view of the substrate S (such as lamp bulb 10 or exhaust tube 50) and exemplary light rays. Grating 30 is shown as a single layer 40 of generally uniform thickness t having a fairly uniform pattern of holes 42 with a grating constant g defined therethrough. The substrate S, e.g., quartz glass, has a first refractive index n₁. The protective layer 44, where present, or where absent, air or other gas layer contacting the grating, has a second refractive index n₂, which may be the same or different from refractive index n₁. Where multiple protective layers 44 are provided, one on top of the other, each layer 44 may have the same or a different refractive index. The layer 44 may extend into the holes 42 to contact the surface 32 of substrate S. The layer 40 has a reflective surface 70 capable of reflecting incident IR radiation back towards the filament 18.

The system consisting of the substrate S and grating 30 (and the protective layer 44 where present), transmits light below a critical wavelength λ_{cr}. Above this critical wavelength, a significant part of the light is reflected back from the grating. The angle(s) at which the light that has passed through grating travels is represented by θ. The critical wavelength λ_{c} is the wavelength at which θ is 90° from normal to the grating, i.e., parallel with the substrate. The critical wavelength depends on the refraction index n₁ of the substrate and protective layer n₂ and the grating parameters. While grating constant g may be optimized using theoretical calculations, in one embodiment, it is optimized experimentally, e.g., by forming lamps with differ values of w and determining which lamp has the highest lumens/watt during operation. The spectral distribution of reflected intensity, or in other words, the effective reflectance of the system, depends on the absorption of the substrate and grating material and the light scattering effects. A typical reflectance vs. wavelength function shows that the transition between the reflection and transmission is not quite as sharp as in the case of IR reflective films formed as multilayer mirrors. In a halogen lamp this effect can decrease the efficiency of IR back reflection to the filament. However, careful positioning of the grating and pattern parameters (e.g., grating constant and spacing of the holes) can compensate for this to a significant degree. The smoothness of the reflective surface 70 also impacts the degree of scattering, and thus the sharpness of the cutoff. A highly smooth surface may have a sharper cut off than a less smooth surface.

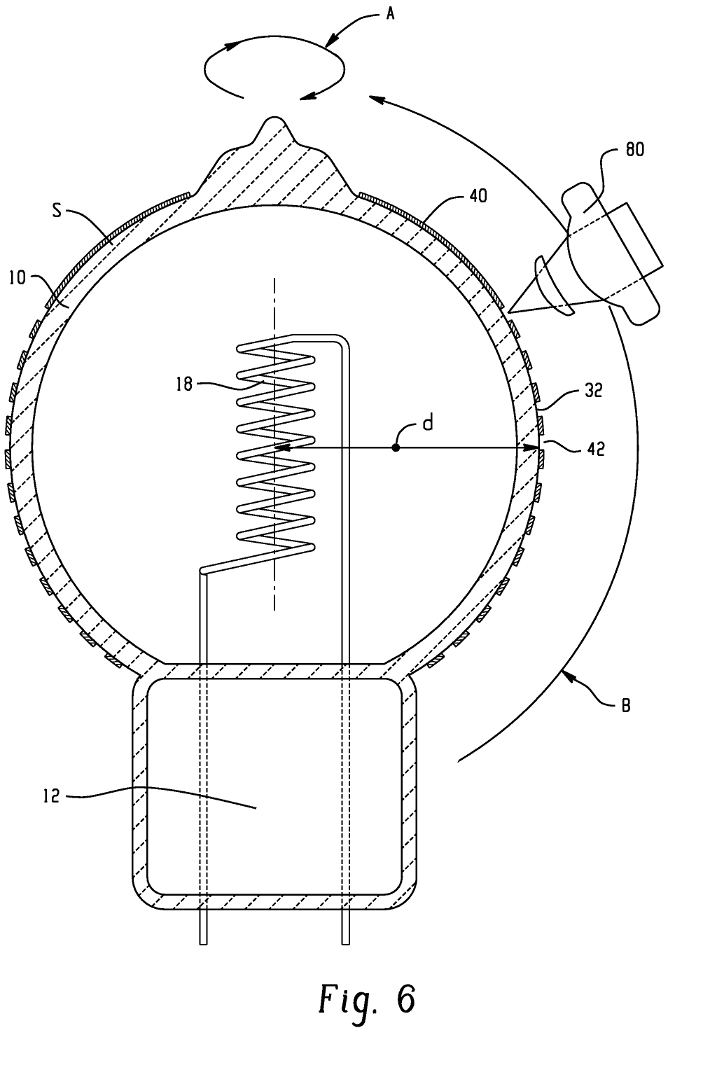

FIG. 6 schematically illustrates an exemplary method of forming the lamp of FIG. 1. In a first step, a continuous layer 40 is applied to the substrate surface, here, the outer surface 32 of the already formed lamp bulb 10. The layer 40 may be applied as a coating, for example, by spin coating, dip coating, Ion-Assisted-Deposition (IAD), vacuum deposition methods, such as sputtering, thermal evaporation, chemical vapor deposition (CVD), or physical vapor deposition (PVD), or the like. For example, a layer of copper, gold, palladium, or other selected IR reflective material is first deposited on the exterior surface of the glass or quartz envelope 10 or other substrate S to a thickness of between about 20-1000 nm (nanometers), e.g., about 50-100 nm by thermal evaporation of a copper source and vacuum deposition of the copper onto the substrate.

Thereafter, the layer 40 is partially removed, e.g., patterned to define holes 42. The patterning may be achieved with a maskless process, e.g., using a laser light source such as a laser beam head 80, or other collimated light, electron or ion source, to form a micropattern. The pattern is generated by an associated control system, such as an electronic circuit or computer (not shown) which controls the actuation of the head 80 and modulation of the beam. In the exemplary embodiment, the lamp bulb is rotated about the lamp axis by a rotation device (not shown), as indicated by arrow A, while the laser head 80 is moved in an arc B, generally parallel with the surface 32. A control device (not shown) may be used to continuously control the position of the head 80 to maintain a uniform distance between the head 80 and the surface 32 during the patterning. The coating material is melted from the layer surface, in small spots, and evaporated by an appropriately controlled and focused laser beam in such a way that the spots together functionally form an optical grating 30. This so-called laser lithography technique may be performed analogously to that employed in CD-ROM burning. However, in the exemplary embodiment, the spot size and spot structure and spacing are relatively uniform and are selected such that the transmittance in the visible range and the reflectance in the infrared range of the formed optical grating 30 are sufficiently high.

In the exemplary embodiment, the patterning may be completed by a single laser head in about 4-8 seconds for a typical spherical bulb with a diameter d of about 12 mm. This is much shorter than for a typical multilayer deposition process. As will be appreciated, a plurality of heads 80 may be employed. For example, with a double laser head, the time can be approximately halved.

In other embodiments, the holes 42 are defined using a mask. For example, a photoresist layer is formed over the layer 40. The photoresist layer can be selectively patterned, e.g., with a modulated UV laser beam. After development, the material from the holes can be removed by etching.

Thereafter, a protective coating 44 may be applied over the patterned layer 40, for example, by any of the methods disclosed above for deposition of the layer 40. In one embodiment, a layer of magnesium fluoride is generated by evaporation of a magnesium fluoride source and vacuum deposition onto the patterned layer.

In another embodiment, a pre-patterned film optionally also comprising a protective layer, may be shrunk wrapped, fused, or otherwise applied to the substrate S to form the grating 30.

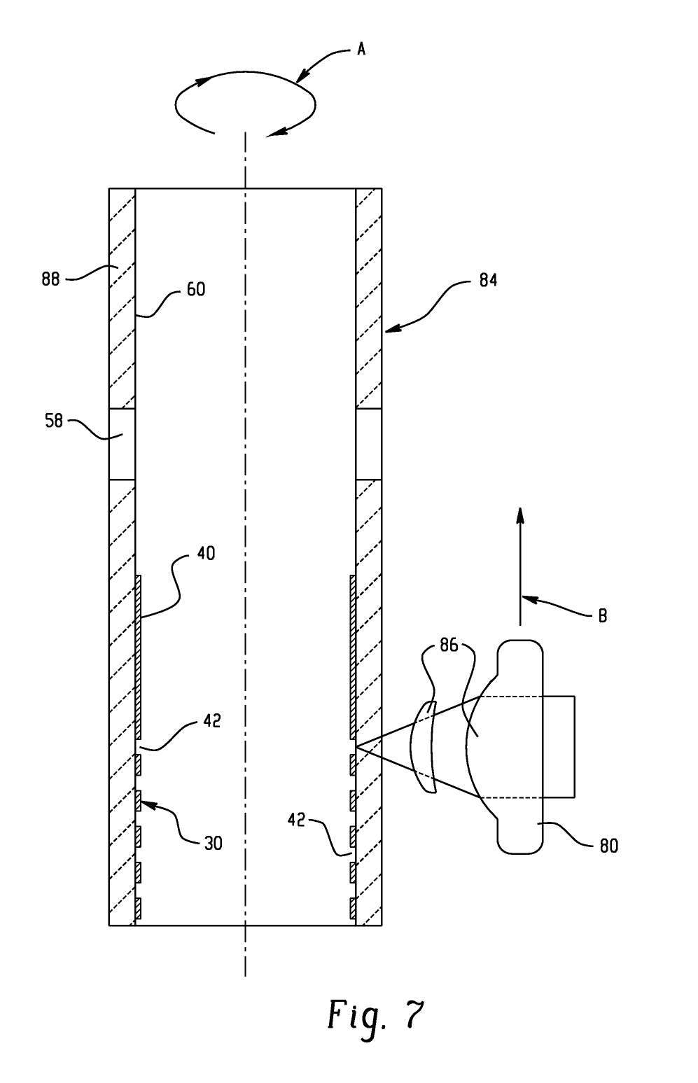

FIG. 7 schematically illustrates an exemplary method of forming the lamp of FIG. 3, which may be similarly performed to the method of FIG. 6, except as otherwise noted. In a first step, a layer 40 is applied to the substrate surface, here, an interior surface 60 of a cylindrical member 84, which is to constitute the exhaust tube 50 in FIG. 3, although the layer 40 may alternatively be deposited on an exterior surface. The cylindrical member 84 may incorporate holes which are to define the convection holes 58 in the finished lamp. Thereafter, the layer 40 is partially removed, e.g., patterned to define a micropattern of holes 42, e.g., using a laser beam head 80 as described above. In the exemplary embodiment, the cylindrical member 84 is rotated about its axis by a rotation device (not shown), as indicated by arrow A, while the laser head 80 is moved in direction B, generally parallel with the surface 60. Here, since surface 60 is generally cylindrical, direction B can follow a linear path. Optionally, a focusing system, such as a lens or group of lenses 86, is used to control the shape of the holes 42. For example, the focusing system may be selected to generate substantially square holes. A similar focusing system 86 may be employed in the embodiment of FIG. 6.

Thereafter, a protective coating 44 may be applied over the patterned layer 40.

The cylindrical member 84, with the grating 30 formed on a lower portion thereof, is then sealed to the upper end of the bulb 10. Thereafter, a filament 18 is inserted and the lamp bulb 10. Then it is pinched at its lower end to define the pinching portion 12 of the lamp. Thereafter, the lamp bulb 10 is filled with the fill gas and finally sealed at the dome 54 to seal the fill in the lamp bulb.

In operation, an electrical current is supplied to the filament 18 of the lamp of FIG. 1, 3, or 4 which causes the filament to emit radiation, generally in all directions. The radiation impinges on the grating 30 and at least a portion of the infrared radiation (e.g., at least 20% and in some embodiments, at least 40% or at least 60%) of the infrared radiation is reflected back towards the filament 18. The substrate S on which the grating 30 is supported can be shaped to enhance the chances that the infrared radiation will be reflected towards the filament, although it is to be appreciated that the reflected radiation may ultimately reach the filament 18 through multiple reflections off the grating 30. The grating 30 allows visible radiation to penetrate therethrough and pass out of the lamp into the exterior.

As will be appreciated, although in the exemplary embodiment, the optical grating 30 is substantially transmissive in the visible range, the optical grating 30 may reflect (and/or absorb) some of the visible light, particularly if the critical wavelength is selected to be close to the upper wavelengths of the visible range or is within the visible range (here considered to be about 400-700 nm). In the exemplary embodiment, however, a significant portion of the visible light incident on the grating 30 is transmitted therethrough, e.g., the grating permits at least 40% and generally at least 60% or in some cases, at least 80% of the visible light generated by the filament 18 to be transmitted from the lamp.

In some embodiments, a totally reflective coating (radiation impermeable layer) (not shown) may be formed over a portion of the lamp bulb 10, such as in the tip region 38, which reflects all or substantially all radiation incident thereon back into the bulb chamber 14. This layer has no holes or substantially no holes formed therein.

While the exemplary lamp is described in terms of a halogen incandescent lamp, it is to be appreciated that the exemplary grating 30 may find application in other lamps which emit radiation in the IR range, such as ceramic metal halide lamps, regular incandescent lamps, and the like.

Without intending to limit the scope of the exemplary embodiment, the following Example demonstrates the effectiveness of the optical grating.

### EXAMPLE

To model the exemplary lamp of FIG. 1, a bulb of a conventional halogen lamp (G4 single ended quartz (SEQ) lamp) was covered with an optical grating by applying a thin pre-patterned film to the lamp bulb exterior surface. The film was formed of a thin metallic layer with holes burned therein on a polymeric substrate. For experimental purposes, the patterned film was simply loosely wrapped around the lamp bulb and the protective coating was not specifically formulated for withstanding high lamp operating temperatures. Prior to applying the film, measurements of the coil temperature using wavelength measurements at 1100 and 1500 nm in both transmitted and reflected light from the film were made. From these measurements, it was determined that the pre-patterned film exhibited good reflectance and poor transmittance in this wavelength range.

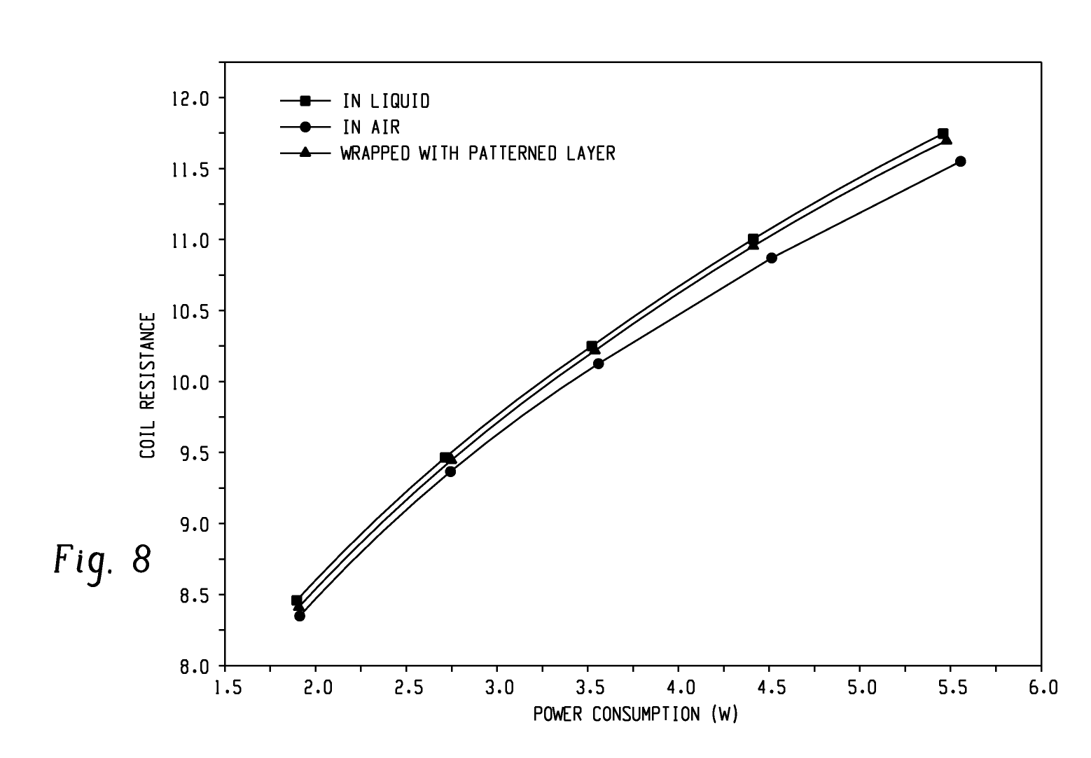

The coated lamp (lamp A) formed in this manner was connected with a DC power source and currents measured at various lamp voltages. Comparative measurements were made on the same lamp without a coating (lamp B) and on the same lamp dipped into a liquid (lamp C), which serves as a reflective mirror. Lamp C serves as a control measurement, since Hg has good reflectivity throughout the whole infrared range. Measurements were made from 4 to 8 V. Above this voltage, the bulb temperature was too high for the polymer substrate to withstand, and it began to melt. From the measured current and voltage data, the power consumption (V*I) and coil resistance (V/I) data was calculated and is represented in FIG. 8. Since there is a high correspondence between the coil temperature and measured coil resistance, FIG. 8 suggests that there are real efficiency differences between the coated lamp and uncoated lamp under similar circumstances.

In particular, it can be seen that, with increasing power consumption of the foiled lamp the coil resistance (i.e., increasing coil temperature) A approaches that of the lamp C (in liquid), or in other words, a similar coil temperature can be achieved at same power consumption, which is higher than achieved in lamp B (in air). This effect can be attributed to the fact that, according to Planck's law, the filament 18 radiates more energy at higher temperature in the lower wavelength range, and the perforated layer is more reflective in the longer wavelength range, while the liquid has good reflectance in the whole visible and IR range.

While the exemplary lamp is described in terms of a halogen incandescent lamp, it is to be appreciated that the exemplary grating may find application in other lamps which emit radiation in the IR range, such as ceramic metal halide lamps, regular incandescent lamps, and the like.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A lamp comprising:
a bulb which is sealed to define an interior chamber;
an emitter disposed within the interior chamber which, during operation of the lamp, emits radiation in the visible and infrared regions of the spectrum;
an optical grating positioned to intercept radiation from the emitter, the optical grating reflecting infrared radiation and transmitting visible radiation therethrough.

2. The lamp of claim 1, wherein the grating comprises a layer patterned with holes.

3. The lamp of claim 2, wherein the layer has a thickness of less than 2000 nm.

4. The lamp of claim 1, further comprising a transparent substrate, the optical grating being supported on the transparent substrate.

5. The lamp of claim 4, wherein the transparent substrate comprises a portion of the bulb.

6. The lamp of claim 4, wherein the transparent substrate comprises an exhaust tube at least partly disposed within the interior chamber.

7. The lamp of claim 1, wherein the emitter comprises a filament.

8. The lamp of claim 7, wherein the transparent substrate is spaced from the filament by a fill gas.

9. The lamp of claim 7, wherein the grating is spaced, on average, from the filament by a distance of from 1 mm to 20 mm.

10. The lamp of claim 1, wherein the emitter comprises a halogen-containing fill disposed within the interior chamber.

11. The lamp of claim 1, wherein the grating has a thickness of 20-100 nm.

12. The lamp of claim 1, wherein the grating is predominantly formed of metal.

13. The lamp of claim 11, wherein the optical grating comprises only a single layer, optionally with a protective coating thereover.

14. The lamp of claim 1, further comprising a protective coating over the optical grating.

15. A method of forming a lamp comprising:
forming a layer on a transparent substrate;
patterning the layer to remove a portion of the layer; and
incorporating the transparent substrate with the patterned layer thereon into a lamp, the lamp including an emitter, which during operation of the lamp, emits visible and infrared radiation, the emitter being spaced from the patterned layer, whereby during operation of the lamp, the patterned layer acts as an optical grating which is substantially transmissive to visible radiation and reflects infrared radiation.

16. The method of claim 15, wherein the patterning includes forming holes through the layer.

17. The method of claim 15, wherein the patterning includes laser lithography.

18. The method of claim 15, wherein the lamp includes a bulb which defines the transparent substrate and the forming of the layer comprises forming the layer on a surface of the bulb.

19. The method of claim 15, wherein the lamp includes an exhaust tube which defines the transparent substrate and the forming of the layer comprises forming the layer on a surface of the exhaust tube.

20. The method of claim 15, further comprising disposing a halogen-containing fill within an interior chamber, the transparent substrate contacting the fill.

21. The method of claim 15, further comprising forming a protective layer over the optical grating.

22. A method of operating a lamp comprising:
energizing a radiation emitter of a lamp such that the emitter emits visible and infrared radiation; and
intercepting the emitted radiation with an optical grating, the optical grating being transmissive to visible radiation and reflecting infrared radiation back towards the radiation emitter, whereby the lamp has a higher lumen output per watt than without the optical grating.
